(19) United States
(12) Patent Application Publication
(10) Pub. No.: US 2015/0027610 A1
(43) Pub. Date: Jan. 29, 2015

(54) PNEUMATIC TIRE FOR CYCLE WHEEL

(71) Applicant: MAVIC SAS, Metz-Tessy (FR)

(72) Inventor: Jean-Pierre MERCAT, Chavanod (FR)

(21) Appl. No.: 14/341,249

(22) Filed: Jul. 25, 2014

(30) Foreign Application Priority Data
Jul. 26, 2013 (FR) 13 01807

(51) Int. Cl. B60C 15/024; B60C 15/04

(52) U.S. Cl. CPC B60C 15/024; B60C 15/04; B60C 2015/0245; B60C 2015/042
USPC 152/540; 152/544

(57) ABSTRACT

A pneumatic tire for a cycle wheel comprising a casing and two beads positioned on respective ones of lateral sides of the casing, the pneumatic tire having the shape of an open torus and defining an inner volume, at least one of the two beads having a shoulder projecting outward of the portion of the casing adjacent thereto, and a support positioned along a radial plane at a second end of the bead, the shoulder being positioned along a radial plane at a first end of the bead and comprising, on its outer surface, a first support surface and an edge, the first support surface being positioned between the edge and the casing, and the support surface being set back with respect to the edge. In a radial plane, the normal direction of the first support surface is substantially tangent to the casing, the support comprising a second support surface positioned on the inner side. The longitudinal modulus of the bead, or the equivalent modulus of the various constituent elements of the bead, is less than 2000 Mpa, and the transverse modulus of the bead, or the equivalent modulus of the various constituent elements of the bead, is greater than 50 Mpa or greater than 100 MPa.

### CROSS-REFERENCE TO RELATED APPLICATION

This application is based upon French Patent Application No. 13/01807, filed Jul. 26, 2013, the disclosure of which is hereby incorporated by reference thereto in its entirety, and the priority of which is claimed under 35 U.S.C. §119.

### BACKGROUND

1. Field of the Invention

The present invention relates to a cycle wheel, such as a wheel for a bicycle, and, in particular, a wheel that includes a pneumatic tire of a new kind. The present invention also relates to a rim for receiving such new kind of pneumatic tire.

2. Background Information

Cycle wheels fitted with air-inflated tires have been used since the early 20th century. Currently, there are two families of pneumatic tire for bicycles, including tubular tires, commonly referred to as “tubular tires”, and beaded tires, commonly referred to as “clincher tires,” or simply “tires”. These two major families each have advantages and disadvantages.

The patent document FR 778 744 discloses a tubular tire including a ring made of fabric, which can be coated with rubber, and both edges of which are stitched to one another to form a torus. Prior to stitching, an inner tube is inserted within the torus. A tread is then adhered to the outside of the torus. The tubular tire is attached to the rim with an adhesive. This attachment is relatively good because the bonding surface is large. However, the heat generated by braking may, in certain cases, melt the adhesive and cause accidents.

When mounted on a rim, a tubular tire operates a slight friction fit on the rim. For a tensioned spoke wheel, the friction fit results in a loss of about 1.0 daN of the spoke tension. Upon inflation of the tubular tire to 8.0 bars, the friction fit increases slightly and the total tension loss is about 8.0 daN. This tension loss is negligible, compared to the tension of the spokes of a wheel which can reach 100 daN for a competition cycle wheel. In fact, in a wheel equipped with a tubular tire, the force exerted by the pneumatic tire and the action of the air pressure on the rim are relatively small and almost negligible. Furthermore, such force has no axial component.

A wheel equipped with a tubular tire has a huge advantage, in terms of lightness. Indeed, the tubular tire itself is lightweight as its toric shape advantageously enables it to withstand high inflation pressure, even with a flexible and light structure. The flexibility (stiffness) of a tubular tire can be evaluated by measuring the increase in the diameter thereof when subjected to a given force. In a known manner, this radial stiffness can be measured by resting the tubular tire on two half-cylinders, and by recording the law, or relationship, that governs the force required to radially space the two half-cylinders apart, depending upon the displacement imposed by the spacing of the two half-cylinders. This recording is ideally performed by means of the half-cylinders being spaced apart and then brought closer together and averaged to cancel the effect of friction; stiffness is then determined by calculating the average slope of the force as a function of the displacement. In this context, as a general rule, the radial stiffness of an uninflated tubular tire is about 1.0 daN/mm, while that of the same tubular tire, when inflated to 8.0 bars, is about 6.0 daN/mm.

Furthermore, because the tubular tire only slightly biases the rim receiving it, the rim can benefit from a relatively lighter construction. Due to this substantial lightness, the tubular tire is the exclusive choice of all professional cyclists. However, the tubular tire has a number of drawbacks, such as complexity of adhesive assembly/disassembly on the rim, repair difficulty, its space requirement and weight when a spare tubular tire must be brought along for repair, its much greater cost than that of the tire, and risks of damage to the tubular tire in the case of runflat running. All these drawbacks have virtually eliminated the use of tubular tires for amateur and recreational cycling.

The other major family of pneumatic tires, namely beaded tires, addresses a number of the disadvantages of tubular tires. In particular, they facilitate the disassembly/reassembly on the rim. The beaded tire is not a closed torus, as is the tubular tire, but rather an open torus, the upper portion of the rim (the upper bridge and lateral flanges) providing the closure thereof. Beaded tires are widely used on land vehicles of all types: including bicycles, motorcycles, and automobiles.

Two inextensible beads are required for proper functioning. These beads, due to their circumferential band strapping, thus take up almost the entire radial force component exerted by the air pressure on the carcass of the pneumatic tire. Thus, when a tire is inflated to 8.0 bars, the tension of each of the beads reaches about 200 daN. Thus, these beads must be very strong so as not to break under tension and repeated fatigue generated during the ride, but they must also be very rigid so as not to overly expand due to air pressure and to avoid the risk of blowing off the rim by expanding and then passing over the outer edges of the rim. These beads, which can be made of steel or composite material, are heavy. The pair of beads of a road bike tire can weigh between 40 g and 100 g depending upon their constituent material and the cross section. In comparison with that of a tubular tire, the stiffness of a tire comprising two beads is about 80 daN/mm, and can reach 240 daN/mm for tubeless tires, which is about 13 to 40 times that of an inflated tubular tire.

In the cycle industry, the first beaded tires were mounted on straight side rims, before the appearance of hook edge rims. The patent document FR 2 351 803 describes a hook edge rim, or flanged rim, for mounting beaded tires. Structurally, a beaded tire rim must be much stronger than a rim of the same size for a tubular tire and, therefore, much heavier. Indeed, when a tire is inflated to a pressure of 8.0 bars, it radially biases the rim to such an extent that a loss of about 30 daN of spoke tension can be observed. This centripetal radial bias is substantially proportional to the inner width of the rim, to its diameter, and to the pressure. By mechanically isolating the tire/rim system, one can show that the centripetal radial action of air pressure on the rim corresponds substantially to the opposite of the centrifugal radial action of the carcass on the beads. The rim flanges must also resist the axial biases exerted thereon by the tire beads, which push them open.

Finally, because the beads are inextensible and must be able to pass over the hooks, or flanges, in order to mount and dismount the tire, a relatively deep groove is required to receive the bead portion diametrically opposite that which is passed over the hook. Therefore, the rims provided to receive pneumatic tires of the beaded type have a relatively substantial depth, generally greater than 7.5 mm. In order not to be overly sensitive to bending, the walls of this deep groove should be rather thick and, therefore, heavy.

Generally speaking, for a tensioned spoke wheel fitted with beaded tires, the spoke tension is dependent upon the inflation pressure; the more the inflation pressure increases, the more the bias exerted by the tire on the rim increases, and the more the tension decreases. Wheels for beaded tires must therefore be overstretched during manufacture in order to obtain the required tension when the tire is inflated.

The spoke sets are asymmetrical on bicycle rear wheels, and it is observed that when the pressure of such a wheel equipped with a pneumatic tire is varied, the relaxation of both asymmetrical spoke sets causes a slight off-centering of the rim. It is therefore necessary to also anticipate this phenomenon at best, by compensating via an initial opposite offset during manufacture of the wheel.

When a beaded tire is punctured, the loss of pressure is generally very fast because the junction between the rim and the tire is not provided to be air-tight. This sudden loss of pressure can be very dangerous, especially in downhill mountain passes. In addition, when tire pressure is reduced to zero, it is very common for the tire to come off the rim, thereby often causing a total loss of control of the cycle, unlike the tubular tire that remains adhered to the rim.

In addition to the ease of assembly, pneumatic beaded tires also enable “tubeless” assembly under certain conditions. The patent document FR 2 829 969 describes a “tubeless” wheel. This latter solution has the advantage of limiting the number of punctures by almost completely eliminating those due to pinching, but also by mitigating the puncture effects as deflation occurs more slowly. However, the total weight of the wheel is even greater with a tubeless wheel than with a wheel with an inner tube. Indeed, the beads must be more rigid and therefore heavier, on the one hand, and the rim must be stronger and have a profile that is compatible with the primary air-tightness during inflation, on the other hand. It is notable in the aforementioned document that the grooves receiving the tire beads are very deep, extending up to half the rim height.

The consequence of the weight drawback affecting the wheels and beaded tires in general, and the tubeless wheels in particular, is that no road or track professional cyclist uses beaded tires, and that, even in bicycle touring, tubeless tires are very seldom used. In fact, the use of tubeless tires is currently confined in the field of mountain biking, in which the weight of the equipment is less critical than in the field of road cycling.

### SUMMARY

The present invention overcomes the drawbacks of the prior art.

The invention in particular achieves a cycle wheel, for road cycling as well as mountain biking (MIB), which is as lightweight as a tubular tire wheel and as practical as an open pneumatic tire wheel. The invention provides a lightweight cycle wheel with greater ease of use.

The invention provides a cycle pneumatic tire comprising a casing and two beads positioned on the respective ones of two lateral sides of the casing, the pneumatic tire having the shape of an open torus and defining an inner volume; at least one of the two beads having a shoulder projecting outward from the portion of the casing that is adjacent thereto, and a support positioned along a radial plane at a second end of the bead; the shoulder being positioned along a radial plane at a first end of the bead and comprising a first support surface and an edge on its outer surface; the first support surface being located between the edge and the casing, and the support surface being set back with respect to the edge, the support comprising a second support surface positioned on the inner side.

A pneumatic tire according to the present invention has any technically acceptable combination of the following features:
in a radial plane, the normal direction to the first support surface is substantially tangent to the casing;
the bead is substantially non-deformable;
the setback depth of the first support surface with respect to the edge of the shoulder is greater than 0.2 mm;
the longitudinal modulus of the bead, or the equivalent modulus of the various constituent elements of the bead is less than 2000 Mpa;
the transverse modulus of the bead or the equivalent modulus of the various constituent elements of the bead is greater than 50 Mpa in a particular embodiment and greater than 100 Mpa in another embodiment;,
the normal direction to the second support surface and the normal direction of the first support surface form an angle between 70° and 110° in a particular embodiment and between 75° and 105° in another embodiment;
the bead, along a radial plane, has an elongate cross section in which the greater extension, or length, of the bead is greater than 1.6 times its thickness;
the bead cross section has a substantially triangular shape, in which the bead thickness in the area of the shoulder is greater than in the area of the support;
the bead comprises an annular core, the longitudinal modulus of which is less than 2000 Mpa, and the transverse modulus of which is greater than 50 Mpa, in a particular embodiment, and greater than 100 Mpa in another embodiment;
the casing of the pneumatic tire includes at least one panel of fibers embedded in rubber; this panel at least partially encloses the core, and the equivalent transverse modulus of the bead thus comprised of the core and the panel is greater than 50 Mpa in a particular embodiment and greater than 100 Mpa in another embodiment;
a radial reinforcement at least partially encloses the core; the radial reinforcement comprising a plurality of fibers parallel to one another and oriented in a radial plane;
the core is made of a material having a density of less than 2.0;
the bead is an element separate from the casing, which is affixed thereto by stitching, gluing, or welding;
the bead comprises a yoke used for fixing it to the casing, the yoke having a height between 4.0 mm and 15 mm in a radial plane in a particular embodiment and between 6.0 mm and 13 mm in another embodiment;
the yoke of the bead is sandwiched within the casing;
the material of the bead has a modulus between 50 Mpa and 2000 Mpa;
the material of the bead has a Shore D hardness greater than 40;
the material of the bead has a density less than 2.0;
the radial stiffness of the pneumatic tire is less than 8.0 daN/mm;
the width of the tire is between 18 mm and 60 mm;
the pneumatic tire is symmetrical with respect to a median plane, and both beads are identical.

The invention also provides a cycle wheel rim having an axis (A) and a median plane (M) perpendicular to such axis, the rim comprising an upper bridge and at least one left lateral flange extending from the upper bridge and extending radially outward so as to move away from the axis, the upper bridge including a stop positioned on the same side as the left lateral flange in relation to the median plane, so that the left lateral flange and the stop demarcate a left channel open upward; the left lateral flange being extended by a hook projecting radially towards the axis and axially towards the median plane so as to come closer to the axis and the median plane. Along a radial plane, the channel opening amplitude, defined by the distance between the hook and the stop is less than the greatest amplitude of the channel.

A rim according to the present invention has any technically acceptable combination of the following features:
the lower end of the hook is separated from the left lateral flange so that a portion of the inner volume of the channel is radially further outside than the lower end of the hook;
the depth of the channel, measured between the top of the hook and the bottom of the channel, is less than 6.0 mm in a particular embodiment and less than 5.0 mm in another embodiment;
the front surface of the hook comprises a first abutment surface, and the front surface of the stop comprises a second abutment surface, and the normal direction of the first abutment surface and the normal direction of the second abutment surface form an angle between 75° and 105°;
the radial amplitude of the upper bridge, which corresponds to the difference in diameter between the portion of the upper bridge closest to the axis (A) and the portion of the rim furthest from the axis (A), is less than 7.0 mm in a particular embodiment and less than 6.0 mm in another embodiment;
the axial extension of the volume of the channel positioned under the hook is greater than 0.6 mm in a particular embodiment and greater than 0.8 mm in another embodiment;
the axial extension of the volume of the channel positioned under the stop is greater than 0.8 mm in a particular embodiment and greater than 1.0 mm in another embodiment;
along a radial plane, the first abutment surface is a line segment;
along a radial plane, the second abutment surface is a line segment;
along a radial plane, the first abutment surface is a circle arc;
along a radial plane, the second abutment surface is a circle arc;
the rim is symmetrical in relation to the median plane and includes a hook, a stop, and a right channel;
the rim is at least partially made of an aluminum alloy;
the rim is at least partially made of a composite material;
the rim according to the invention is also includes a greater extension, or length, of the channels, the amplitude of which is less than 8.0 mm;
the rim width is between 18 mm and 40 mm.

The invention also provides a cycle wheel with an axis (A) having a median plane (M) perpendicular to the axis (A), the wheel comprising a rim and a pneumatic tire, in which:
the rim includes an upper bridge and at least one left lateral flange extending from the upper bridge and extending radially outward so as to extend away from the axis (A), the upper bridge including a stop positioned on the same side as the left lateral flange in relation to the median plane, so that the left lateral flange and the stop demarcate a left channel, the left channel having, along a radial plane, an opening having an amplitude (a), a greater extension (c) greater than the aforementioned opening, and a cross section having a surface area (Sg);
the pneumatic tire comprising a casing and at least one left bead which, along a radial plane, has a greater extension (d), a thickness (e) less than (d), and the cross section of which has a surface area (St);
the greater extension of the bead (d) is greater than the amplitude (a) of the opening;
the thickness (e) of the bead is less than or equal to the amplitude (a) of the opening;
the surface area (St) of the bead cross section is less than the surface area (Sg) of the channel cross section;
the bead has a transverse modulus between 50 and 2000 MPa.

In a particular embodiment, the left lateral flange is extended by a hook projecting radially towards the axis (A) and axially towards the median plane (M) so as to come closer to the axis (A) and the median plane (M). The bead has a shoulder projecting outward from the portion of the casing adjacent thereto, the shoulder being positioned, along a radial plane, at a first end of the bead so that, when the tire is inflated, the shoulder comes into contact with the hook.

In a particular embodiment, the front surface of the hook comprises a first abutment surface. The lower end of the hook is separated from the left lateral flange such that a portion of the inner volume of the channel is radially located further outside than the lower end of the hook. The shoulder, at its outer surface, comprises a first support surface and an edge, the first support surface being positioned between the edge and the casing, and the support surface being set back with respect to the edge, so that when the pneumatic tire is inflated, the first support surface bears against the first abutment surface, and the edge is received in the upper volume of the channel.

In a particular embodiment, the front surface of the stop comprises a second abutment surface, whose normal direction (A₃₇) and the normal direction (A₃₅) of the first abutment surface form an angle between −75° and 105°. The bead comprises a support positioned, along a radial plane, at a second end of the bead and comprising a second support surface positioned on the inside, the normal direction (A₃₅) of the first abutment surface and the normal direction (A₃₇) of the second abutment surface forming an angle between −75° and 105°, and the normal direction (A₆₇) of the second support surface and the normal direction (A₆₅) of the first support surface forming an angle between 75° and 105°.

### BRIEF DESCRIPTION OF DRAWINGS

The invention will be better understood upon reading the description, with reference to the annexed drawings, in which:

FIG. 1 is a view of a wheel according to a first embodiment of the invention;

FIG. 2 is a cross-sectional view along a radial plane of the wheel of the first embodiment of the invention;

FIG. 3 is a detailed view of FIG. 2 showing a portion of the rim;

FIG. 4 is a detailed view of FIG. 2 showing a portion of the pneumatic tire;

FIG. 5 is a detailed view of FIG. 2 showing the balance of forces between the pneumatic tire and the rim;

FIGS. 6a-6g are detailed views showing the various phases of positioning of the bead in the channel;

FIG. 7 is a view of the wheel of the first embodiment in a beading situation;

FIGS. 8a, 8b, 8c, 8d are views of alternative versions of the bead of a pneumatic tire according to the invention;

FIG. 9 is a cross-sectional view according to a second embodiment of the invention;

FIG. 10 is a cross-sectional view according to a third embodiment of the invention;

FIG. 11 is a detailed perspective exploded view of the pneumatic tire bead according to the third embodiment of the invention;

FIG. 12 shows a variation of the third embodiment of the invention; and

FIGS. 13, 14, and 15 show a wheel according to a fourth embodiment of the invention.

### DETAILED DESCRIPTION

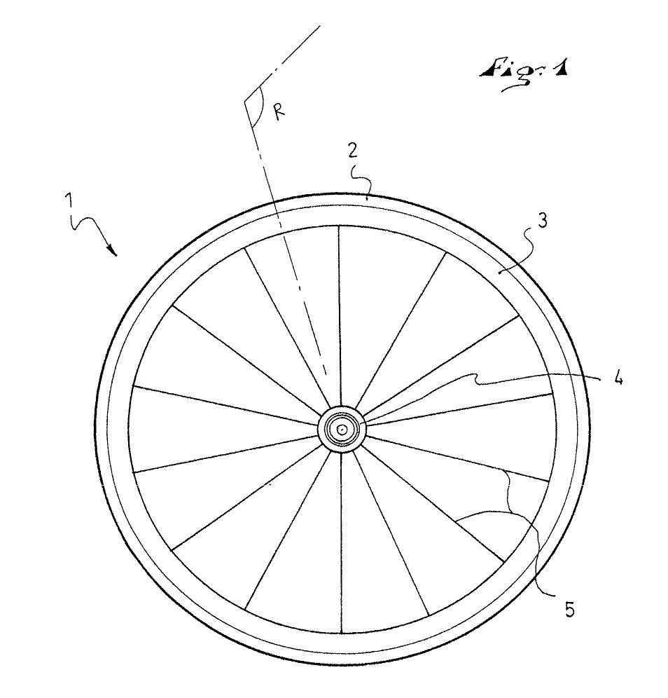

FIG. 1 shows a wheel 1 according to the invention. This wheel includes a pneumatic tire 2 and a rim 3 according to the invention, as well as a hub 4 and spokes 5. The scope of the invention is not limited to wheels equipped with tensioned spokes because compression spoke wheels or disc wheels according to the invention are also embraced by the invention. This is a cycle wheel, such as for a bicycle. Unlike automobile wheels in particular, cycle wheels are characterized by a greater lightness and a tire inflation pressure that can be much more substantial. Indeed, the mass of a cycle wheel seldom exceeds a few kilograms (between 1.0 kg and 4.0 kg), whereas that of an automobile wheel never drops below 10-15 kg. The invention is particularly applicable to the field of bicycle wheels for racing, especially for road racing. Indeed, in this context, the weight of a complete wheel is less than 2.0 kg and 1.0 kg for the most efficient ones, whereas the inflation pressures reach 10 bars, while they are less than 3.0 bars in the fields of automobile and motorcycles.

FIG. 2 shows a cross section of a wheel in a radial plane (R), according to a first embodiment of the invention. FIG. 2 and most of the subsequent views are cross sections made in the radial plane (R). In the context of this disclosure, a radial plane (R) refers to any plane in which the axis (A) of the wheel is included. In a known manner, the rim 3 is formed by a closed torus having an axis (A), i.e., the axis of the wheel. This torus is symmetrical in relation to a median plane (M). It is demarcated by a lower bridge 38, an upper bridge 31, and two side walls 33. Above this torus is arranged the zone for interfacing with the pneumatic tire. This interface zone includes two lateral flanges 32 extending the side walls and a central base 36. The base 36 is formed by the central portion of the upper bridge 31 projecting upward in relation to the lateral portions of the upper bridge. Throughout the following description, the orientation concepts such as “upward” and “downward” refer to the cross section of the wheel shown in FIG. 2. Consequently, “upward” indicates a radial direction away from the axis (A) of the wheel, whereas “downward” indicates a radial direction closer thereto. Similarly, the “inward” orientation corresponds to an axial direction towards the median plane (M) of the wheel, whereas “outward” corresponds to an axial direction away from the median plane (M).

A left channel 341 is thus defined between the base 36 and the left lateral flange 321. Symmetrically, a right channel 342 is defined between the base 36 and the right lateral flange 322.

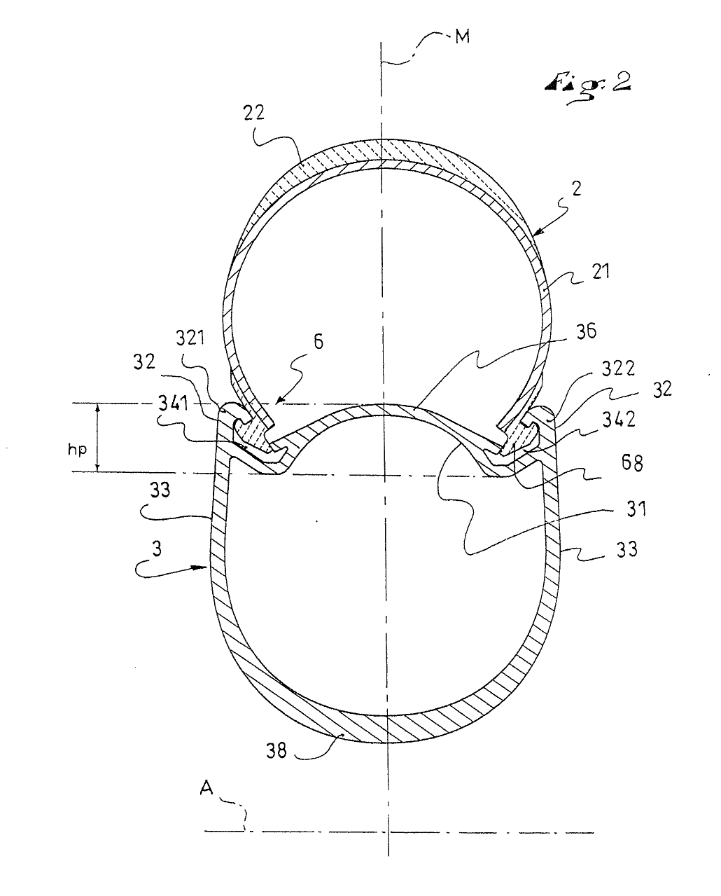

FIG. 3 is a detailed view of FIG. 2, showing the left channel 341, which forms a semi-closed toric volume demarcated by the inner surface of the left flange 321, the top of the left lateral portion of the upper bridge 31, and the base 36. The left flange 321 is extended by a hook 35, or lip, turned downward and inward. In the illustrated embodiment, the left flange 321, which extends upward from the junction between the left lateral wall 331 and the upper bridge 31, forms a downward bend to obtain the hook 35. The hook ends with a front surface constituting a first abutment surface 353. This first abutment surface 353 is a tapered surface, whose intersection with a radial plane is a line segment which, together with the axis (A) of the wheel, forms an angle β between 10° and 80°. The axis (A₃₅) is defined as the direction perpendicular to the first abutment surface 353. In the embodiment described here, the front surface of the hook is perpendicular to the latter, so that the axis (A₃₅) also corresponds to the orientation axis of the hook 35. The angle β′ formed in the radial cross-sectional plane between the axis (A₃₂) of the left flange 321 and the orientation axis (A₃₅) of the hook 35 is substantially equal to the angle β, because the flanges 32 are substantially vertical, on the one hand, and the first abutment surface 353 is perpendicular to the axis (A₃₅), on the other hand.

The base 36 ends on its left portion with a stop 37. The latter has a second tapered abutment surface 373 whose intersection with a radial plane is a line segment forming an angle γ with the first abutment surface 353. In a particular embodiment, the angle γ is between 70° and 110°. In the embodiment described here, the angle γ is equal to 90°.

The axis (A₃₇) is defined as the direction perpendicular to the second abutment surface 373. In a particular embodiment, the axis (A₃₇) and the axis (A) of the wheel form an angle β of between 30° and 80°.

As mentioned above, the left channel 341 is a semi-closed toric volume, the opening of which is formed between the hook 35 and the stop 37. This opening is made from the top and inward, that is, towards the median plane of the wheel. Indeed, the stop 37 is lower and further inside in relation to the hook 35. The opening amplitude, provided by the distance (a) between the hook 35 and the stop 37, is less than the greater extension (c) of the channel 34. In the embodiment described here, the greater extension of the channel corresponds to the distance between the recess of the bend of the left flange 321 and the inner bottom of the left channel 341. This distance (c) is equal to about 4.5 mm, whereas the distance (a) is equal to 2.2 mm.

A portion of the inner volume of the channel is radially positioned at the top, in relation to the lower end 356 of the hook 35. Indeed, the lower end of the hook is separate from and does not come into contact with the inner surface of the left lateral flange, so that a space is created between the hook and the lateral flange. This space is referred to as the upper volume 345 of the channel. The axial extension (r₃₅) of the volume of the channel positioned under the hook 35 is greater than 0.6 mm in a particular embodiment and greater than 0.8 mm in another embodiment.

Another portion of the inner volume of the channel is positioned under the stop 37; this space is referred to as the mounting volume 375 of the channel. The mounting volume is positioned below the second abutment surface 373 in relation to the median plane (M). The axial extension (r₃₇) of the mounting volume 375 is greater than 0.8 mm in a particular embodiment and greater than 1.0 mm in another embodiment.

A rim according to the invention has a shallow depth for the left and right channels in relation to its height. Indeed, the depth (h), which corresponds to the difference in elevation between the bottom of the channels and the top 325 of the lateral flanges 32, is less than 30% of its height (H) in a particular embodiment and 25% in another embodiment. In absolute value, the depth (h) of a rim according to the invention is less than 6.0 mm in a particular embodiment and less than 4.5 mm in another embodiment.

A rim according to the invention has no deep groove in the central portion of the upper bridge and, more generally, the radial amplitude of the upper bridge is small. Referred to as (hp) is the radial amplitude of the upper bridge 31, which corresponds to the difference between the diameter of the portion of the upper bridge closest to the axis (A) of the wheel and the diameter of the portion of the rim farthest from the axis (A). In the first embodiment, the portion of the upper bridge closest to the axis is constituted by the bottom of the channels and the farthest rim portion is constituted by the top of the central base and the top of the lateral flanges. As explained in the summary, this radial amplitude has a non-negligible effect on the total weight of the rim, because the more substantial this amplitude, the larger the walls of the upper bridge should be. In a rim according to the invention, this amplitude can be reduced in proportions never reached for the manufacture of metal rims for racing bikes. The amplitude (hp) is less than 7.0 mm in a particular embodiment and less than 6.0 mm in another embodiment. A rim having an amplitude (hp) of about 4.0 mm can reasonably be considered within the scope of the invention.

As can be seen in FIGS. 1 and 2, the pneumatic tire 2 has the shape of an open torus. It includes a flexible casing 21 and two beads 6. The casing 21 is overlaid by a tread 22. In the embodiment described here, the casing 21, the tread 22, and the beads are separate elements stitched and/or adhered to one another with an adhesive. As described below, these elements can be made as a single piece.

FIG. 4 is another detailed view of FIG. 2, partially showing the pneumatic tire 2. The left bead 61 shown therein is entirely constituted by a core 68 separate from the remainder of the casing 21. This core has a non-circular cross section, the precise shape of which is described in detail below. The core 68 is comprised of an appendage 64, a yoke 63 for fixing the core 68 to the casing 21, and a base 66 connecting the yoke 63 and the appendage 64. The appendage 64 includes a shoulder 65 projecting outward of the pneumatic tire at a first end, and a support 67 at the other end. The outer surface of the shoulder 65 includes a surface which, with the portion of the casing 21 adjacent thereto, forms an angle α between 75° and 105°. This surface forms the first support surface 653 of the bead. In the embodiment described here, the angle α is substantially equal to 90°. In the cross-sectional plane, the axis (A₆₅) corresponding to the direction perpendicular to the first support surface 653 in its center is substantially tangent to the casing 21. The end portion of the shoulder 65 forms an edge 654. The first support surface 653 is set back in relation to the edge 654 and the yoke 63 that frame it. The value r₆₅ measures the setback depth of the first support surface 653. Preferably the value r₆₅ is greater than 0.2 mm, preferably greater than 0.3 mm.

The surface of the support 67 facing the inner volume of the tire is substantially smooth and forms a second support surface 673 for the bead. The axis (A₆₇) is the normal direction to the second support surface. Between the first 653 and second 673 support surfaces of the bead, the angle 5 is between 70° and 110°. The angle δ is also found between the axes (A₆₅) and (A₆₇) to the extent that, in this embodiment, the intersection of the first and second support surfaces with the radial plane involves straight lines.

A guiding surface 655 is located beneath the shoulder 65. This surface is substantially parallel to the second support surface 673.

The distance (d) corresponding to the greater extension of the appendage 64, between the shoulder 65 and the end of the support 67, is greater than the thickness (f) of the base 66. In the embodiment described here, the distance (d), which is equal to 3.4 mm, is more than two times greater than the thickness (f), which is equal to 1.2 mm.

The bead has a substantially elongated triangular shape, the zone of the shoulder having a greater thickness than the zone of the support.

The length of the yoke approximately defines the bonding interface height (i) between the bead and the casing. This height is sufficient to enable this interface to withstand the stresses to which it is subjected. In particular, the tire inflation causes cohesion stresses, especially shear stresses in the yoke of the bead and the carcass of the tire casing. These shear stresses increase with the tire inflation pressure and decrease with the length of the bonding interface measured in a radial cross section. In practice, the yoke and/or the bonding interface are provided with a height (i) greater than 4 mm. However, to avoid overly stiffening the tire, the height (i) can be limited, in particular to a value of 15 mm. Good results are obtained with a yoke having a height between 6.0 mm and 13 mm.

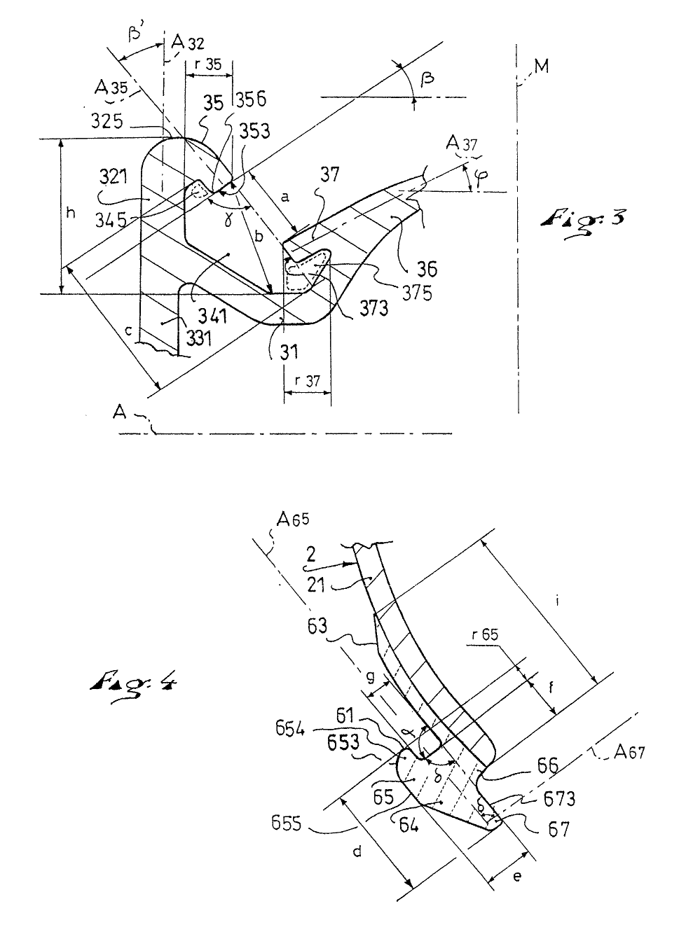

FIG. 5 shows the linear forces (tangent force per unit length) present in the area of the rim/pneumatic tire interface when the tire is inflated to a pressure of 10 bars. The cohesive force F₁ corresponds to the force to which the pneumatic tire is subjected due to the inflation pressure. This force is approximately 12.5 N/mm (for a tire of 23 mm); it is tangentially applied to the casing, at point P. It is mainly taken up by the reaction F₂ of the hook which is applied at point C. The offset of points P and C creates a moment which is taken up by the reaction of the stop which is exerted at point B.

Advantageously, in a wheel according to the invention, the cohesive force exerted at the lower portion of the pneumatic tire is mainly taken up by the rim and not by the bead as is the case in a beaded tire, such as are known in the prior art. Therefore, the air pressure exerted centripetally on the upper bridge 31 and its base 36 is thus compensated for and balanced radially by the centrifugal action of the tire on the hooks of the rim, thereby canceling the deformation of the rim and the relaxation of the spokes due to the air pressure.

The bead of the pneumatic tire of the invention must therefore meet a number of specifications in order for the wheel to withstand an inflation pressure of 10 bars. The bead forms a membrane portion which must resist transverse bending, which tends to deform it until the support bends and the bead disengages from the channel. The bending stiffness of a membrane having a thickness (e) is characterized by the product (Pr) of its modulus (E) multiplied by the cubed thickness “Pr=E·e³”. To limit the total mass of the pneumatic tire, the thickness (e) of the bead is selectively limited to 3.5 mm in a particular embodiment and less than 3.0 mm in another embodiment. Due to the presence of the shoulder, the thickness (e) is greater than 1.0 mm in a particular embodiment and greater than 2.0 mm in another embodiment.

The transverse bending strength desired for the bead according to the invention is characterized by a product (Pr) greater than 800 Nm in a particular embodiment and greater than 2000 Nm in another embodiment. Therefore, the transverse modulus for the bead must be greater than 50 Mpa in a particular embodiment and greater than 100 Mpa in another embodiment.

Furthermore, the bead must also have a tensile strength so as not to tear under the effect of the inflation pressure. The bead and the base 66 are subject to very high shear stresses. In the example described here, the shear stresses in the base 66 reach 7.5 MPa. For reasons of convenience, pneumatic tires for cycles are now folded when stored and sold, and they must be capable of being unfolded without damage before use. To reassume its shape of use without problem after folding, the bead must have an elongation at yield and sufficient tensile strength. For all these reasons, a bead must be designed with a tensile strength of at least 15 MPa.

As discussed below, the mounting and dismounting of tires require a radial expansion of the pneumatic tire and, therefore, radial flexibility of the bead. The longitudinal modulus of the bead characterizing the ability to stretch the pneumatic tire so as to slightly enlarge the diameter thereof is less than 2000 MPa, thereby yielding a tire stiffness less than 5.0 daN/mm (the stiffness is also proportional to the bead cross section) in order to ease the mounting of the tire.

In the first embodiment, the bead is entirely formed by the core 68, and the latter is made of a single material. The aforementioned framing values of the moduli apply directly to the constituent material of the core. It is shown below that the invention is not limited to such an embodiment. Indeed, the construction of the bead and of the core of the bead can be made with two or more materials. For example, in addition to a core having the properties mentioned above, the complete bead may further include one or more layers covering the core completely or partially. For example, this core may be covered with a fabric, a thin layer of elastomer or rubber. This core is not equivalent to a flexible or rigid bead, such as those currently used in the manufacture of tires, especially bicycle tires. Indeed, its longitudinal modulus must be such that it makes it possible to mount the pneumatic tire by extending its diameter on a rim according to the invention, that is to say, a shallow rim. Conversely, its transverse modulus must be such that the bead does not deform excessively and resists the bending and shear stresses to which it is subjected. In cases in which the bead is a composite structure having a plurality of components, the aforementioned moduli correspond to the equivalent moduli of the composite structures. The equivalent moduli are the result of a calculation taking into account all the components of the bead, their geometries and intrinsic characteristics, and yielding an equivalent deformation with an equivalent homogeneous material.

The bead core may be entirely made of a single material, and this material should have a certain transverse modulus of elasticity, that is to say, along a radial plane. This is particularly important inasmuch as the shoulder 65 and support 67 will be subject to bending during use, while the base 66 is subject to very high shear stresses. In the example described herein, the shear stresses in the base 66 reach about 7.5 MPa at a pressure of 10 bars. However, the constituent material of the core of the bead has a longitudinal modulus, which is considerably less than that of steel or fibers (e.g., Kevlar) which are commonly used to make pneumatic tire beads. In practice, a material having a transverse modulus greater than 50 Mpa is selected for a particular embodiment and greater than 100 Mpa in another embodiment.

A material suitable for the manufacture of the core of the bead, or the bead itself, according to the invention has a modulus between 50 and 2000 Mpa, that is, at least 50 times more rigid than natural rubber, and at most 100 times less rigid than steel, both of which are reference materials used in the manufacture of pneumatic tires. It further has a tensile strength greater than 15 MPa.

Good results are obtained with materials having a modulus between 100 and 2000 MPa.

For a particular embodiment, this material has a Shore D hardness greater than 40 (a modulus of approximately 100 MPa). Pneumatic tires for cycles are currently made with rubbers having a Shore A hardness of 60−70, which substantially corresponds to a modulus of elasticity of about 1.5 Mpa to 3.0 MPa.

The bead core 68 is relatively large. For example, in this embodiment, the cross section of the core is about 6.0 mm². Therefore, to avoid weighing down the pneumatic tire, a material with a density less than 2.0 g/cm³ can be selected.

In any event, the bead cross section should be reduced in order to lighten the tire. Thus, the bead cross section can be limited to less than 16 mm² in a particular embodiment and less than 10 mm² in another embodiment. For example, for a wheel having a perimeter of about 1950 mm, a pair of beads each having a cross section of 10 mm² and made of a material having a density of 1.0 g/cm³ weighs about 39 g for the pair, which is not negligible in the total mass of the tire.

By way of example, the thermoplastic bead can be made via bi-material extrusion using PEBAX® 7033 (Arkema) for the lower zone of the bead in the vicinity of the support zone 65, and PEBAX® 4033 for the upper zone of the yoke 63. PEBAX® 7033 has a Young Modulus of about 380 MPa (50<380<2000), a Shore D hardness of 69 (69>40), and a rupture strength of 52 Mpa, while PEBAX® 4033 has a modulus of about 80 MPa (50<80<2000), a Shore D hardness of 46 (46>40), and a rupture strength of 37 MPa, while their density is 1.02 g/cm³.

If the bead is adhesively affixed to the carcass of the pneumatic tire, it is desirable to incorporate chemical compatibilizers adapted to provide good adhesion to the assembly or to coextrude a thin layer of elastomer around the bead. These different techniques are described in French patent FR 2 729 397.

In a variation of the first embodiment, the bead is formed by the assembly of two distinct materials. The shoulder/support assembly is then made of a first material and the yoke of a second material. The two materials used can be two elastomeric and/or thermoplastic phases linked by a biphasic compatibilizer as described in French patent FR 2 749 018,

Other materials suited for the manufacture of the core of the bead include, for example, Hytrel® (Dupont de Nemours), PEBAX® (Arkema), Elastolan® (BASF polyurethane elastomer), HDPE (High Density Polyethylene), Rilsan® (Arkema Polyamide 11), Grilamid® (EMS Polyamide 12), or synthetic fabrics coated with rubber and vulcanized. This list is not exhaustive, and other materials, not mentioned, are also suitable.

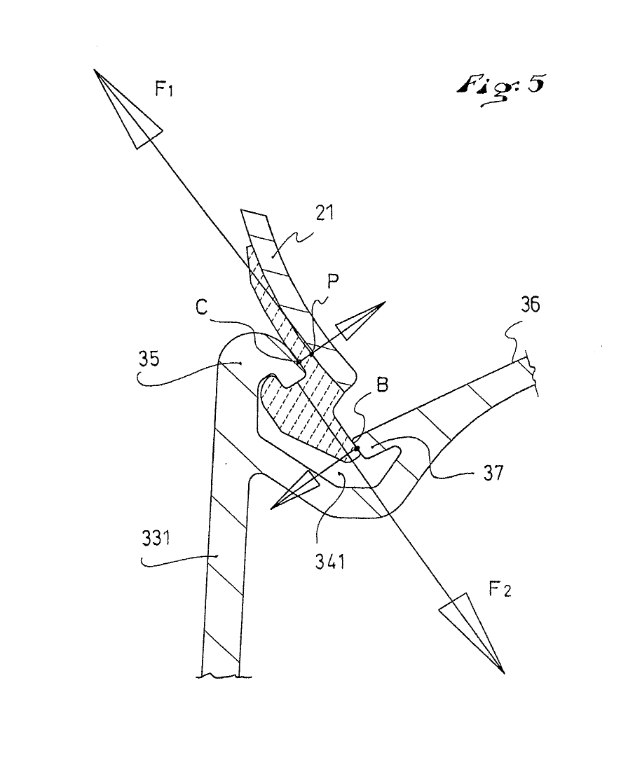

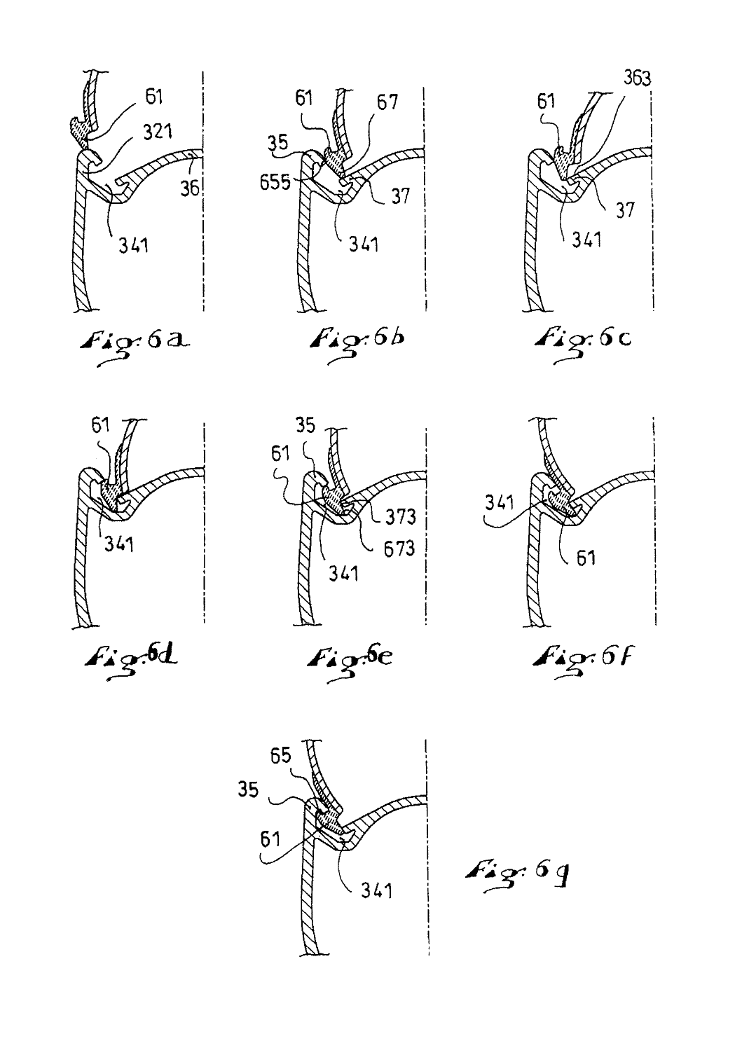

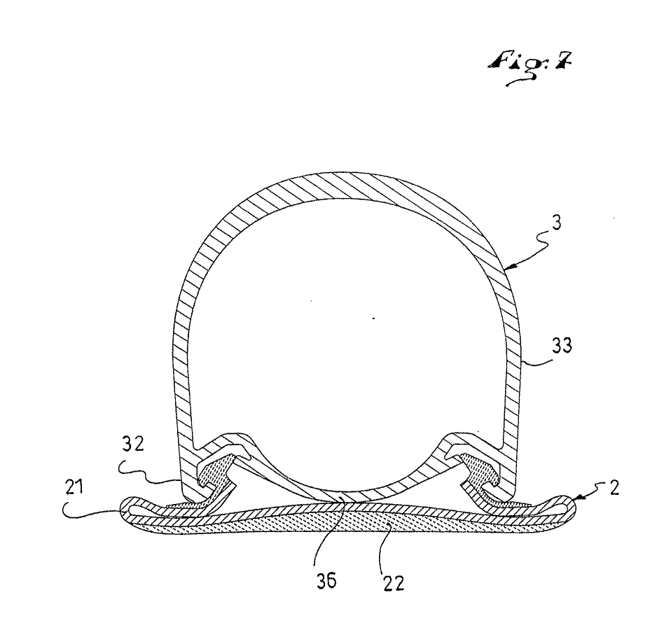

FIGS. 6a-6g show how to mount a pneumatic tire and a rim according to the invention. This series of views show the assembly of the left bead 61 in the left channel 341.

In FIG. 6a, the largest portion of the circumference of the left bead 61 (>300°) is already positioned in the channel. This positioning is simply carried out in the same manner as for any pneumatic tire. It only remains to pass the remaining portion of the left bead)(<60° over the left flange 321. Due to the shallow depth of the left channel, the left bead portion, directly opposite that left to be passed over the flange, cannot be moved inward of the wheel to facilitate the passage over the flange. However, the longitudinal modulus of the bead, which is greater than that of the pneumatic tire casing, is such that it is possible to expand the bead diameter by about 10 mm to enable passage of the bead over the flange.

FIG. 6b illustrates the step following the passage of the bead over the left flange 321. The elasticity of the pneumatic tire forces the support 67 to come against the base 36 and the guiding surface 655 of the appendage to take support against the hook 35.

It then suffices to pivot the bead by deforming the pneumatic tire casing until it is in the configuration of FIG. 6c. Advantageously, the base comprises a sliding surface 363, on which the support 67 slides. In this configuration, the thickness (e) of the appendage enables it to slide into the opening until the support takes support on the bottom of the channel, as shown in FIG. 6d.

The greater extension of the appendage (d) is less than the distance (b) between the hook 35 and the bottom of the channel. Thus, when the stress deforming the tire is released, the elasticity of the tire generates a rotation of the bead that passes the shoulder beneath the hook (see FIG. 6e). The tilting occurs until the second support surface 673 of the support is in flat support against the second abutment surface 373 of the stop (FIG. 6f).

However, unlike the pneumatic tire casing, the bead is substantially non-deformable. Thus, to enable the bead to become housed in the channel, it is necessary to change the relative orientation of the bead in relation to the casing.

The position shown in FIG. 6f is a stable position that is uniform over the entire periphery of the wheel as the inner diameter of the free tire is, in a particular embodiment, a few millimeters less than the diameter of the channel bottom. In this situation, the primary air-tightness of the pneumatic tire is ensured, and the user can proceed to inflate it with a primary air-tightness making it possible to increase tire pressure with the low flow rate of a classic manual pump, despite the small transient leakages of the bead. This primary air-tightness is much more effective than on the tubeless system described in the document FR 2 829 969, which requires a high flow rate to initiate the tire inflation. In the position shown in FIG. 6f, the support penetrates in the mounting volume 375 of the channel.

The final position of the pneumatic tire (FIG. 6g) is obtained after inflation, when the shoulder 65 slides beneath the hook 35 under the effect of pressure. The space 345 is then filled by the edge 654. The first support surface 653 is then in contact with the first abutment surface 353 of the hook 35. The second support surface is in abutment against the second abutment surface.

The bead of the pneumatic tire according to the invention is not deformable due to its modulus that is much higher than that of rubber. However, a number of its characteristics enable it to be easily inserted into the channel. Firstly, the particular shape of the bead cross section, in particular an elongated triangular shape in which the distal end formed by the support is thinner than the proximal end formed by the shoulder. Then, the surface area (St) of the bead cross section along a radial plane is much less than that of the channel (Sg). The surface area (Sg) is at least 20% greater than the surface area (St) of the bead.

FIG. 7 shows the wheel in a beading situation. This situation can occur if the wheel violently comes in contact with an obstacle and, at a point, the air is expelled from the portion where the rim is in almost direct contact with the obstacle. The presence of the base 36 makes it possible to distribute the forces to which the rim is then subjected. The rim according to the invention is thus better protected from the beading effects, and the likelihood of puncture by pinching is greatly reduced. Similarly, the rim is better protected from the runflat effects. Furthermore, the relative arrangement of the stop and the hook is such that, in the event of beading, the anchoring and air-tightness of the pneumatic tire are reinforced. Thus, the risks of loss of inflation pressure and blowing off the rim are minimized.

The wheel described in the first embodiment, for example, is intended for road cycling sporting activities. This wheel has a normalized outer diameter of about 700 mm. The height of the rim is 25 mm and the distance from the hook is 19 mm. The pneumatic tire has a diameter of 23 mm. The weight of the tubeless pneumatic tire according to the invention is 190 g and that of the rim is 400 g. These values are to be compared with the respective weights of a tubeless tire and of a rim of the same dimensions and for the same practice, as they are currently manufactured. The weight reduction is 8% of the weight of the rim and 30% of the weight of the tire of the prior art. The weight reduction for the pneumatic tire is mainly due to the removal of beads with very high modulus that are typically used for pneumatic tires, and to a reduction in the perimeter of its casing. The rim weight reduction by reducing the wall thicknesses is made possible by the shallow depth of the channels and less bias on the flanges. Because the tire and the rim are the wheel components that are farthest from the axis of rotation, the advantage of reducing the weight and, therefore, the inertia thereof as much as possible can be understood.

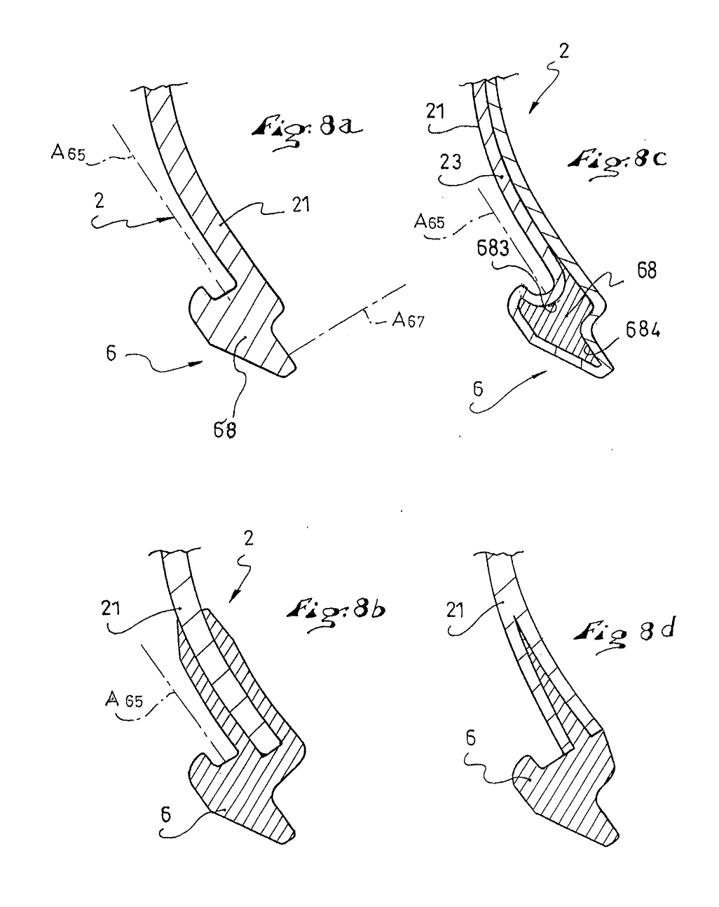

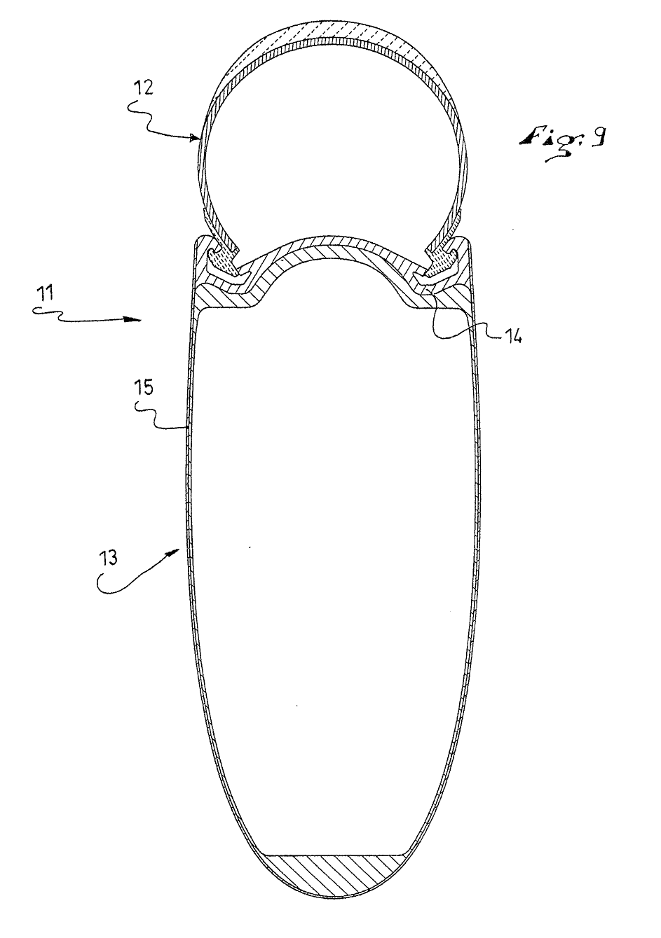

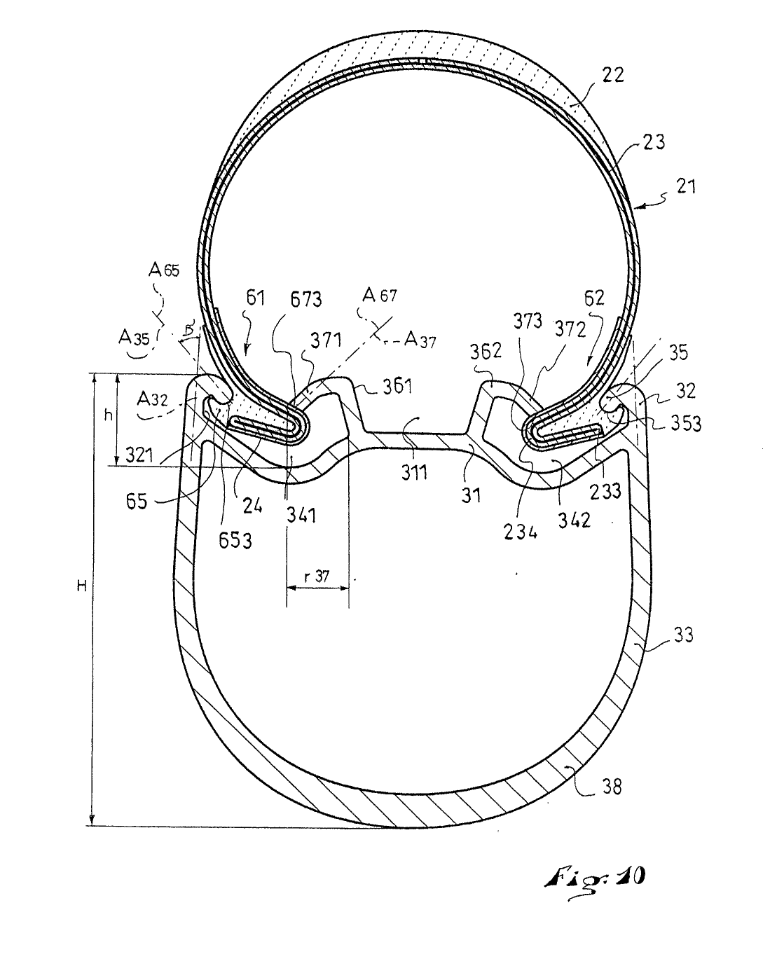

FIGS. 8a, 8b, 8c, and 8d schematically show alternative versions of the bead of a pneumatic tire according to the invention. In FIG. 8a, the bead is unitary with the casing of the pneumatic tire; the modulus of the material can therefore be scalable between the casing 21 and the core 68 in order to provide sufficient rigidity and strength to the bead and the necessary flexibility to the casing. In FIG. 8b, the bead is fixed to the casing by stitching, welding and/or gluing a double yoke. FIG. 8d shows an alternative version in which the yoke 63 of the bead is sandwiched within the casing 21. Although this schematic drawing figure does not describe the construction of the casing 21 in detail, it should be understood that the yoke is inserted between two folds of the pneumatic tire carcass. The alternative versions shown in FIGS. 8b and 8d are particularly advantageous because the length of the bonding interface is thus increased without overly increasing the height of the yoke. Approximately, the length of the bonding interface measured in a radial plane is equal to twice the height of the yoke. FIG. 8c shows a pneumatic tire in which the lower portion of the casing comprises two sections of the same fabric panel 23 folded over itself. In a known manner, the fabric is coated with rubber to provide air-tightness and strength. A core 68 is embedded between the two sections of fabric. The core 68 comprises a first support zone 683 defining a support substantially perpendicular to the casing 21. This first support zone has a concave shape in a radial plane. This concave shape is centered on the axis (A₆₅), which is substantially tangent to the casing 21. The core 68 also has a second support zone 684 oriented substantially in the direction of the casing 21. The core is made of a material having a modulus between 100 Mpa and 2000 MPa.

FIG. 9 shows a second embodiment of a rim according to the invention. This is an aerodynamic wheel 11. This wheel includes a deep rim 13, that is to say, a rim having a height greater than 50 mm. The rim includes a hoop 14 to serve as the interface with the pneumatic tire 12 and as the main body 15 of the rim. The hoop 14 is made of an aluminum alloy, for example by extruding a rectilinear profiled section, and then by bending and welding together the profiled section. The inner profile of the hoop 14 is identical to that of the rim 3 of the first embodiment of the invention and is not described in detail in this paragraph. The main body 15 is made of composite material.

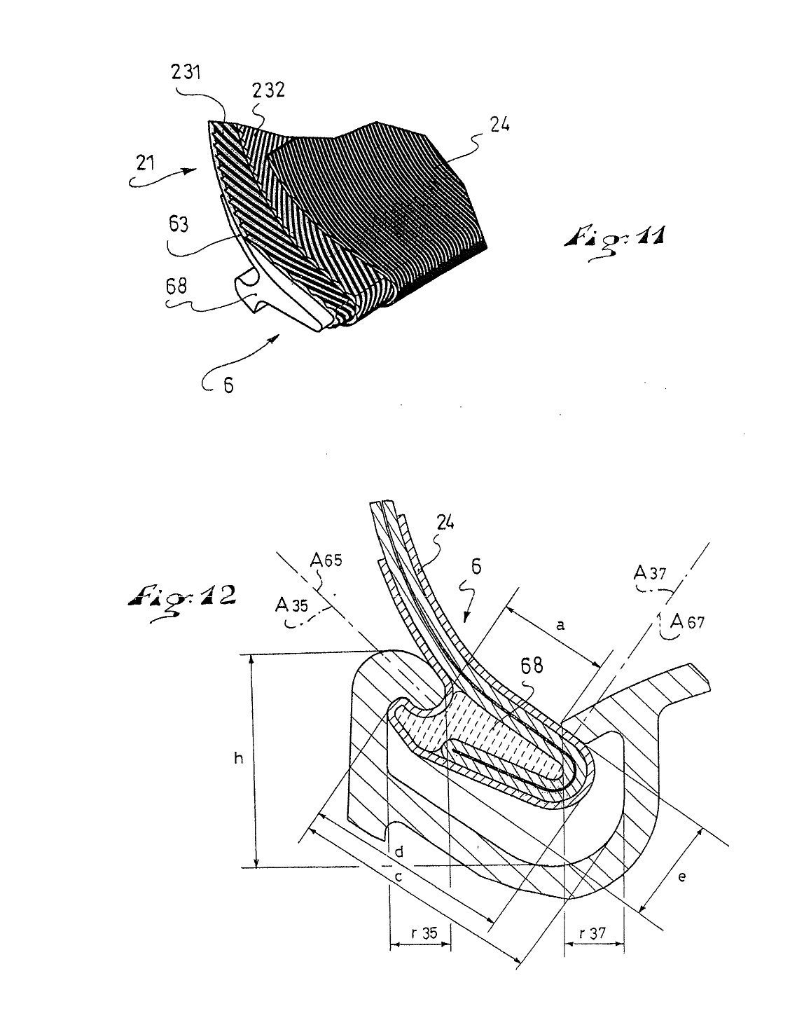

FIG. 10 shows a third embodiment of a wheel according to the invention, which includes a rim 3 conventionally comprised of a lower bridge 38, an upper bridge 31, two side walls, and two lateral flanges 32. According to the invention, the lateral flanges 32 are extended by a hook 35 oriented downward and inward of the rim, and at the end of which the first abutment surface 353 is located.

The first abutment surface 353 is a convex surface which, in the radial plane, has a profile corresponding to a circle arc. As in the previous embodiments, one can define an axis (A₃₅) corresponding to the direction perpendicular to the first abutment surface 353. In this case, as the first abutment surface is not a line segment in a radial plane, the axis (A₃₅) bisects the chord of the circle arc.

In a particular embodiment, the chord of the circle arc of the surface 353 is substantially perpendicular to the hook 35, so that the hook 35 is substantially oriented along the axis (A₃₅). The axis (A₃₅) and the orientation axis (A₃₂) of the lateral flange 32 form an angle β′ between 10° and 80°.

The upper bridge 31 includes a base 36 comprised of two half-bases, a left half-base 361 and a right half-base 362. The left half-base 361 ends with a left stop 371 on its right side, and the right half-base 362 ends with a right stop 372. The front surface of the stops 371 and 372 forms a second abutment surface 373. In the radial plane, the axis (A₃₇) is the direction perpendicular to the second abutment surface 373. The axis (A₃₇) and the axis (A₃₅) of the hook form an angle equal to 80°. A central groove 311 separates the right half-base 361 from the left half-base 362.

In an alternative version, the two half-bases are elements attached to the upper bridge. In this case, the stops can be made of a different material from that of the rim.

A left channel 341 is demarcated by the left hook 351, the inner surface of the left flange 321, the upper bridge 31, and the left base 361. The left channel 341 opens upward, between the first 353 and second 373 abutment surfaces. A left channel 342 is symmetrically demarcated between the right hook 352 and the right half-base 362.

The pneumatic tire 2 according to the third embodiment of the invention includes a casing or carcass 21, on which a tread 22 is vulcanized or affixed with an adhesive. The casing 21 is mainly comprised of a panel 23 folded over itself, a first time, in the area of the right bead 62 and in the area of the left bead 61. The first folding is designated by the reference numeral 233 in the drawing figure. The casing 21 is again folded over itself a second time in the area of the beads. The bead 6 is inserted within this second folding 234. A reinforcement 24 covers the panel 23 in the area of the bead.

The bead 6 is comprised of a core 68 partially covered by the casing 21 of the pneumatic tire. The bead includes a shoulder 65, an outer surface of which constitutes a first support surface 653. This first support surface has a shape complementary to that of the first abutment surface 353. In this case, this surface is concave and has a circular profile. In the radial cross-sectional plane, it is centered on the axis (A₆₅), which merges with the axis (A₃₅) when the tire is positioned on the rim and inflated.

The second support surface 673 is comprised of a lower portion of the inner surface of the tire. More specifically, it is the reinforcement 24 that comes into contact with the second abutment surface 373.

As in the embodiments described above, the bead includes a yoke 63 used for fastening on the casing 21. This yoke is vulcanized or adhesively attached and stitched onto the inner 232 and outer 231 panels.

In this embodiment, the thickness (e) of the bead, equal to 2.9 mm, is substantially equal to, although very slightly less than, the opening amplitude of the channel (a).

FIG. 11 is a cut-away perspective view showing a few details of the pneumatic tire construction. It shows the core 68 of the bead 6 adhered to the outer panel 231. The casing 21 is also formed by the inner panel 232 and the reinforcement 24. The panel 23 used to make the casing 21 comprises a sheet of rubber-coated textile fibers. The fibers are parallel to one another. In the outer panel 231, the fibers form a −45° angle with the radial plane. When the panel 23 is folded over itself, the fiber orientation is reversed so that the fibers of the inner panel 232 form a +45° angle with the radial plane. This arrangement of fibers between both inner and outer panels is particularly optimal for a good compromise between flexibility, strength, and weight of the pneumatic tire.

According to one of the embodiments of the invention, the pneumatic tire further includes a reinforcement 24 whose fibers form a very small angle with the radial plane. In a particular embodiment, this angle is zero; the fibers of the reinforcement 24 are then said to be radial. Due to the orientation of its fibers, the reinforcement 24 improves the rigidity and bending strength of the bead 6 in a radial plane.

The bead core is made of a material having a modulus between 100 Mpa and 2000 MPa, or by winding a small sheet of rubber-coated fabric having fibers also having a very small angle with the radial plane, thereby providing very good rigidity and transverse strength to the bead, while limiting longitudinal rigidity to facilitate the mounting of the tire.

The equivalent modulus of the bead can be calculated as mentioned above by measuring the bead deformation and calculating the equivalent modulus of a bead with identical geometry having the same deformation.

FIG. 12 shows an alternative version of the pneumatic tire bead of the third embodiment of the invention. In this version, the bead 6 does not include a yoke, and the core 68 is entirely covered by the radial reinforcement 24. The thickness (e) of the bead is 2.9 mm in this version, and the greater extension (d) is 5.3 mm. The rim associated with this pneumatic tire is slightly modified. The opening (a) of the channel is 2.9 mm, the greater extension (c) is 6.5 mm, and the depth (h) is 5.85 mm.

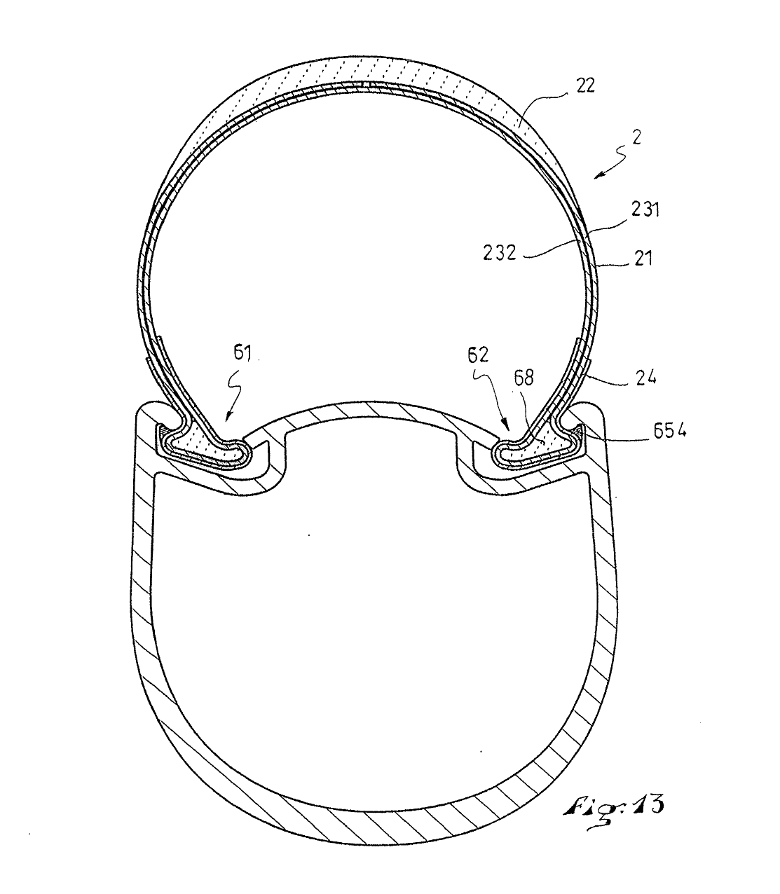

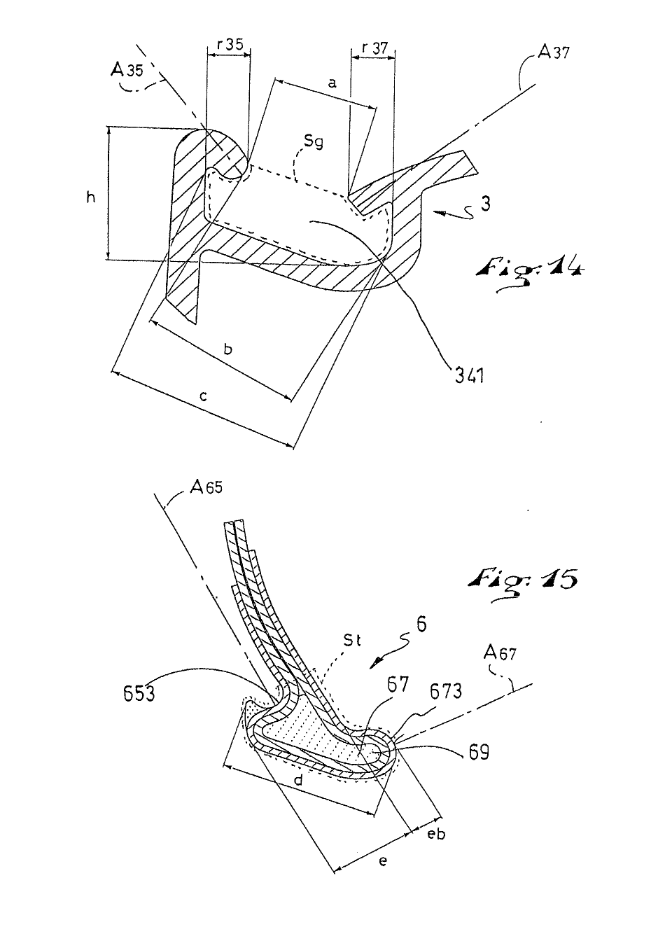

FIGS. 13, 14, and 15 illustrate a fourth embodiment of the invention. All of the elements of this embodiment that are shared with the previous embodiments, or some of them, are not described again with reference to this fourth embodiment. Therefore, only the differences are highlighted below.

The pneumatic tire 2 includes a casing 21 comprised of a panel of fibers embedded in a layer of rubber. The panel is folded over itself at each of both ends of the open torus. Thus, the casing is comprised of an inner panel 232 and an outer panel 231. The two free edges of the panel are joined to one another at the top of the pneumatic tire under the tread 22.

A core 68 is inserted between the inner 232 and outer 231 panels on each side in order to partially shape the left bead 61 and right bead 62. The bead also includes a radial reinforcement 24 and an edge 654 adhered onto the radial reinforcement 24 in the area of the shoulder of the bead.

The radial reinforcement 24 includes a plurality of parallel and radially oriented fibers, and it greatly improves the equivalent transverse modulus of the beads 6. The edge 654 is not biased in bending; therefore, it is acceptable to leave it outside of the radial reinforcement 24. The edge may simply be made of rubber.

The bead 6 of the fourth embodiment according to the invention has a substantially elongated triangular shape, insofar as the thickness thereof in the area of the shoulder 65 is greater than that in the area of the support 67. Moreover, the support projects inward of the pneumatic tire. A bead 69 projects to come closer to the median axis (M). The second support surface 673, provided on this bead 69, is convex. This surface is a circle arc in a radial plane.

The greater extension (d) of the bead is equal to 4.9 mm, whereas its thickness (e) is equal to 2.8 mm. The thickness of the bead 69 is equal to 1.0 mm. The surface area (St) of the bead cross section is equal to about 9.0 mm². As will be shown below, this particular shape and dimensioning makes it possible to optimize the profile of the channels.

The rim 3 of the fourth embodiment of the invention differs from the previously described versions by a further reduced depth, as the depth (h) of the channels is 4.4 mm without being much broader. The greater extension (c) of the channel, measured between the upper end and outer end thereof, beneath the hook, and the bottom thereof, on the inner side, is equal to 6.2 mm. However, the opening (a), equal to 3.2 mm, is larger to facilitate the insertion of the bead, even in a slanted position thereof. The surface area (Sg) of the cross section of the channel is about 12 mm².

The presence of the bead 69, on which the second support surface 673 is arranged, makes it possible to reduce the depth (h) of the channel. Given that the rim is shallow, the stresses in the upper bridge are greatly reduced. The wall thicknesses can then be further reduced and, moreover, as the rim is practically no longer biased in compression under the effect of air pressure, the cross section of the rim can indeed be generally reduced. For comparison, the ETRTO (19TC ATB tubeless cycle tires 27.4) recommends, for beaded tires under similar conditions of use, a minimum total depth (dimension G+H) of 5.85+3.2=9.05 mm, which requires greater wall thicknesses than the invention in order to withstand the higher bending stresses due to the inflation pressure.

In an alternative (not shown) of the fourth embodiment, the bead 69 is positioned, as the edge 654, outside of the radial reinforcement 24. It is made of rubber, for example, because it only works in compression and is not subject to bending.

In another embodiment (not shown) of the invention, the stops are arranged on a separate element of the upper bridge. This element can subsequently be fixed to the upper bridge.

The wheels of the several embodiments described herein by way of examples are typically intended for on-road use. The invention also applies to wheels provided for mountain biking, which, although often used with lower inflation pressures, have pneumatic tires with a greater width (up to 60 mm). Therefore, the linear tensions of the casing of a pneumatic tire for mountain bikes are substantially the same as those of a road tire. The design of the beads as described here is therefore completely transferrable.

The embodiments described do not mention an inner tube because the invention applies irrespectively to wheels equipped with inner tubes as well as tubeless wheels.

It may be desirable to provide a hole or a small channel in the zone of the stop on the rim or the pneumatic tire, so that air pressure in the channels is identical to that of the enclosure of the pneumatic tire and, therefore, that the pneumatic tire pressure does not change over time if a small, very slow leakage were to gradually pressurize the channels and reduce tire pressure.

Lastly, at least because the invention is disclosed herein in a manner that enables one to make and use it, by virtue of the disclosure of particular exemplary embodiments of the invention, the invention can be practiced in the absence of any additional element or additional structure that is not specifically disclosed herein.

1. A pneumatic tire for a cycle, the pneumatic tire comprising:
a casing; and
two beads positioned on respective ones of two lateral sides of the casing;
the pneumatic tire having a shape of an open torus and defining an inner volume;
at least one of the two beads having a shoulder projecting outward from the casing, the shoulder being located, along a radial plane, at a first end of the bead;
the shoulder comprising an outer surface, the outer surface comprising a first support surface and an edge, the first support surface being positioned between the edge and the casing, and the support surface being set back in relation to the edge;
the bead comprising a support positioned, along a radial plane, at a second end of the bead and comprising a second support surface positioned on an inner side;
a longitudinal modulus of the bead, or an equivalent modulus of various constituent elements of the bead, is less than 2000 MPa;
a transverse modulus of the bead, or an equivalent modulus of various constituent elements of the bead, is greater than 50 Mpa.

2. A pneumatic tire according to claim 1, wherein:
in a radial plane, a normal direction of the first support surface is substantially tangent to the casing.

3. A pneumatic tire according to claim 2, wherein:
a normal direction of the second support surface and a normal direction of the first support surface form an angle between 75° and 105°.

4. A pneumatic tire according to claim 1, wherein:
the set-back depth of the first support surface in relation to the edge of the shoulder is greater than 0.2 mm.

5. A pneumatic tire according to claim 4, wherein:
along a radial plane, the bead has an elongate cross section having a length greater than 1.6 times a thickness of the bead.

6. A pneumatic tire according to claim 5, wherein:
the bead comprises an annular core, a longitudinal modulus of the annular core being less than 2000 Mpa, and a transverse modulus of the annular core is greater than 50 MPa.

7. A pneumatic tire according to claim 6, wherein:
the casing includes at least one panel of fibers embedded in rubber;
the panel at least partially envelops the core; and
an equivalent transverse modulus of the bead, thus comprising the core and the panel, is greater than 50 MPa.

8. A pneumatic tire according to claim 7, further comprising:
a radial reinforcement at least partially enveloping the core, the radial reinforcement comprising a plurality of fibers parallel to one another and oriented in a radial plane.

9. A pneumatic tire according to claim 6, wherein:
the core is made of a material having a density less than 2.0.

10. A pneumatic tire according to claim 1, wherein:
the bead is an element separate from the casing and is fixed to the casing by stitching, gluing, or welding.

11. A pneumatic tire according to claim 10, wherein:
the bead comprises a yoke fixing the bead to the casing;
the yoke has, in a radial plane, a height between 4.0 mm and 15 mm.

12. A pneumatic tire according to claim 10, wherein:
the bead comprises a yoke fixing the bead to the casing;
the yoke has, in a radial plane, a height between 6.0 mm and 13 mm.

13. A pneumatic tire according to claim 12, wherein:
the yoke of the bead is sandwiched within the casing.

14. A pneumatic tire according to claim 1, wherein:
the bead is made of a material having a modulus between 50 MPa and 2000 MPa, a Shore D hardness greater than 40, and a density less than 2.0.

15. A pneumatic tire according to claim 1, wherein:
the tire having a radial stiffness of less than 8.0 daN/mm.

16. A wheel comprising a tire according to claim 1.
